(19) United States
(12) Patent Application Publication
(10) Pub. No.: US 2014/0375638 A1
(43) Pub. Date: Dec. 25, 2014

(54) MAP DISPLAY DEVICE

(71) Applicants: Yoshihiro Tomaru, Tokyo (JP); Shoichiro Kuboyama, Tokyo (JP)

(72) Inventors: Yoshihiro Tomaru, Tokyo (JP); Shoichiro Kuboyama, Tokyo (JP)

(73) Assignee: Mitsubishi Electric Corporation, Chiyoda-ku,Tokyo (JP)

(21) Appl. No.: 14/380,829

(22) PCT Filed: Jul. 30, 2012
(86) PCT No.: PCT/JP12/69330

§ 371 Date: Aug. 25, 2014

(51) Int. Cl. G06T 17/05; G06T 15/40

(52) U.S. Cl. CPC G06T 17/05; G06T 15/40
USPC 345/421

(57) ABSTRACT

A hidden model determinator that compares a coordinate value in a depth direction which is acquired by performing a coordinate transformation on each of a first determination target point and a second determination target point which are selected from model data about a facility model with that in the depth direction of model data about a topographical model, which is stored in a Z value buffer, to determine whether or not the facility model is hidden behind the topographical model, and a facility addition processing unit that stores model data about a facility model which the hidden model determinator determines is not hidden behind the topographical model.

### FIELD OF THE INVENTION

The present invention relates to a map display device having a function of searching for and displaying facilities located around a vehicle.

### BACKGROUND OF THE INVENTION

In recent years, a map display application representing a navigation device has a function of searching for facilities located around a vehicle. At the time of searching for surrounding facilities, facilities, such as convenience stores, hospitals, and post offices, which are located around the vehicle, are displayed on a map as icons or the likes. The user is allowed to refer to the map on which icons showing facilities are displayed, and select a facility which he or she desires by using an input unit such as a facility selection button. The user can also make the device display detailed information about the selected facility, and so on. As a display example, a selected facility is clarified by enclosing the selected icon with a thick frame, and facility information is expressed by character strings. As a method of clarifying a selected facility, instead of enclosing the icon with a thick frame, for example, the display color of the icon can be changed or an arrow indicating the icon can be disposed.

A problem is, however, that when a billboard process of expressing two-dimensional map data in three dimensions is performed, and a terrain undulation is expressed, a facility selected by the user is hidden behind the terrain undulation, and, as a result, the icon of the facility may not be displayed on the map display screen and only the detailed information about the facility may exist on the screen, so that the user cannot recognize the position of the facility which the user has selected. In FIG. 13, this problem is illustrated. FIG. 13(a) shows contour lines of map data with which a map display is produced, and the positions of facilities, and FIG. 13(b) shows a map display screen in which topographical features shown in FIG. 13(a) are viewed from a direction shown by an arrow 900. As shown in FIG. 13(a), although a hospital 901 has been selected, the icon showing the hospital 901 is not displayed on the map display screen of FIG. 13(b), but only character strings 903 showing the detailed information about the hospital 901 are displayed because the hospital 901 is located behind an undulation 902. Therefore, although the user is enabled to select the hospital 901, he or she cannot recognize at which point on the map display screen the hospital 901 is located.

As a method of solving this problem, there is a method of using an occlusion culling technique of detecting an object hidden behind a drawing object to detect an object hidden behind a terrain undulation in advance and to allow the user to remove the object from selectable facility selection targets.

As one occlusion culling method, there is a hidden determination method using a Z buffer. A Z buffer is a storage area that stores the distance from a visual point position to each object in three-dimensional graphics on a per pixel basis. In the hidden determination method using a Z buffer, it is necessary to compare an inner area in the Z buffer corresponding to an object which is a hidden determination target with the Z value of the object on a per pixel basis. A problem is that the comparing process on a per pixel basis is required of the occlusion culling using a Z buffer, and therefore the required amount of computations is large.

As a measure against this problem, patent reference 1 discloses a method of, in order to determine a positional relationship in a depth direction among fragments which construct an object, providing a reduction buffer to which a representative Z value showing a depth from a visual point for each pixel block which is a combination of a plurality of adjacent pixels is assigned, and updating the Z value of each pixel block by using the Z value at the most distant point of the object drawn in the block, i.e., the maximum Z value. As a result, when a positional relationship in a depth direction is determined, only a comparing process performed on a per block basis is required, and the amount of computations can be suppressed as compared with the comparing process performed on a per pixel basis.

### RELATED ART DOCUMENT

### Patent Reference

Patent reference 1: Japanese Unexamined Patent Application Publication No. 2007-310798

### SUMMARY OF THE INVENTION

### Problems to be Solved by the Invention

A problem with the technique disclosed by above-mentioned patent reference 1 is, however, that although the comparing process of making a comparison between the Z values on a per pixel basis is unnecessary, it is necessary to perform the comparing process the number of times corresponding to the number of divided blocks, and therefore the amount of computations required for the comparing process increases depending upon the resolution of the blocks.

The present invention is made in order to solve the above-mentioned problem, and it is therefore an object of the present invention to speedup a process of performing comparing determination of whether or not a map object which constructs map data is hidden behind another map object when producing a map display by performing a billboard process on two-dimensional map data.

### Means for Solving the Problem

In accordance with the present invention, there is provided a map display device including: a map data storage that stores map data; a display range calculator that calculates a map range of a map image to be displayed according to an operational input; an object information acquiring unit that acquires object information about all map objects which construct the map range calculated by the display range calculator from the map data stored in the map data storage; an object selector that acquires object information about a map object of a specified type from the object information acquired by the object information acquiring unit; a transformation matrix calculator that calculates a transformation matrix for transforming the map data into three-dimensional data on the basis of a virtual visual point position for the map image having a three-dimensional expression, a sight line direction, and a three-dimensional parameter which is specified on the basis of the visual point position and the sight line direction; a renderer that renders object information about a map object of a first type acquired by the object selector with the transformation matrix calculated by the transformation matrix calculator, and generates three-dimensional image element data; a buffer that stores the three-dimensional image element data generated by the renderer; a hidden determinator that selects a determination target point from object information about a map object of a second type acquired by the object selector, performs a coordinate transformation on the determination target point with the transformation matrix calculated by the transformation matrix calculator, and compares a coordinate value in a depth direction of the determination target point on which the coordinate transformation is performed with a coordinate value in the depth direction of the three-dimensional image element data stored in the buffer to determine whether or not the map object of the second type is hidden behind the map object of the first type; and a storing processor that stores object information about a map object of the second type which the hidden determinator determines is not hidden behind the map object of the first type, wherein the renderer renders the object information about all map objects other than the map object of the first type, generates three-dimensional image element data, and draws the map image.

### Advantages of the Invention

According to the present invention, in the determination of whether or not a map object which constructs the map data is hidden behind another map object, the number of times that the comparing and determining process is performed can be suppressed, and the comparing and determining process can be speeded up.

### BRIEF DESCRIPTION OF THE FIGURES

FIG. 1 is a block diagram showing the structure of a map display device in accordance with Embodiment 1;

FIG. 2 is an explanatory drawing showing an environmental parameter of the map display device in accordance with Embodiment 1;

FIG. 3 is an explanatory drawing showing an outline of determination of a map movement which is performed by the map display device in accordance with Embodiment 1;

FIG. 4 is a view showing a display example of model data included in a map range of the map display device in accordance with Embodiment 1;

FIG. 5 is a flow chart showing the operation of the map display device in accordance with Embodiment 1;

FIG. 6 is a view showing rendering of a topographical model which is performed by the map display device in accordance with Embodiment 1;

FIG. 7 is an explanatory drawing showing processes which are performed by a determination target point selector 7 and a determination target point coordinate transformer 8 of the map display device in accordance with Embodiment 1;

FIG. 8 is an explanatory drawing showing a process of determining whether or not a facility model is hidden which is performed by the map display device in accordance with Embodiment 1;

FIG. 9 is a view showing a display example in a case of rendering model data other than topographical models in the map display device in accordance with Embodiment 1;

FIG. 10 is a view showing an example in which a display feature adder 13 of the map display device in accordance with Embodiment 1 adds a thick frame as a display feature;

FIG. 11 is a view showing a display example in a case of adding a display feature in the map display device in accordance with Embodiment 1;

FIG. 12 is a view showing a positional relationship between facility models and topographical models in the map display device in accordance with Embodiment 1; and

FIG. 13 is a view showing a selection of a facility model in a conventional map display device.

### EMBODIMENTS OF THE INVENTION

Hereafter, in order to explain this invention in greater detail, the preferred embodiments of the present invention will be described with reference to the accompanying drawings. Embodiment 1.

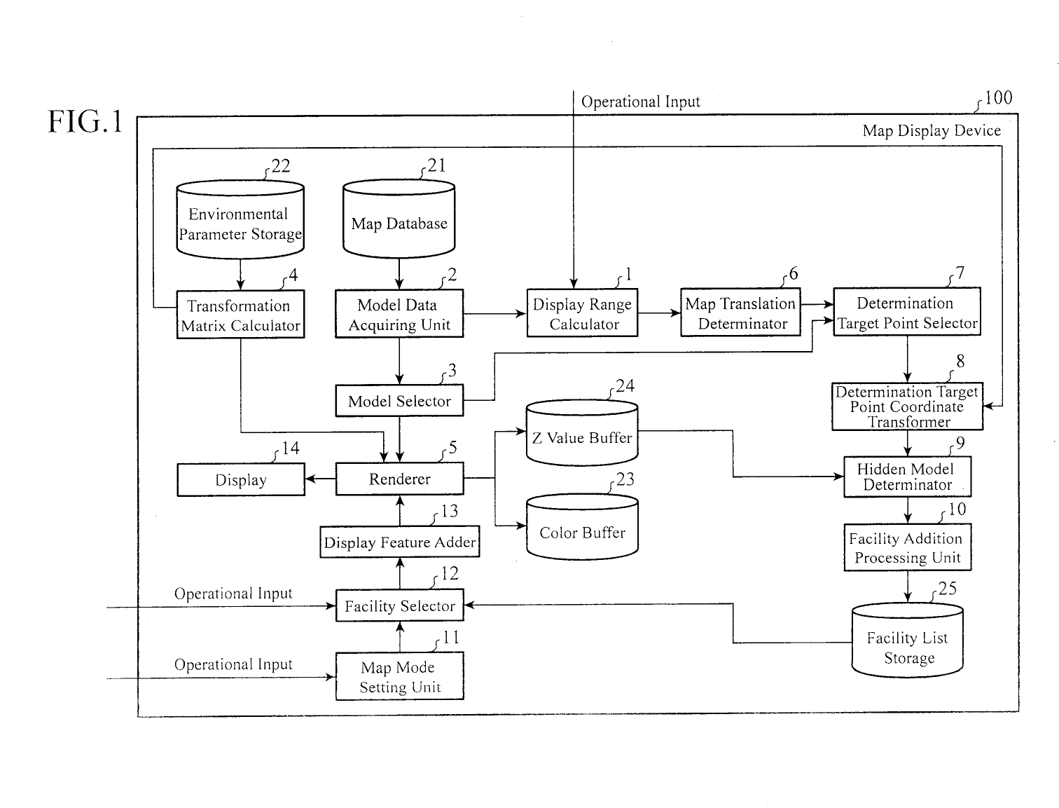

FIG. 1 is a block diagram showing the structure of a map display device in accordance with Embodiment 1 of the present invention. Referring to FIG. 1, the map display device 100 is comprised of a display range calculator 1, a model data acquiring unit (object information acquiring unit) 2, a model selector (object selector) 3, a transformation matrix calculator 4, a renderer 5, a map movement determinator 6, a determination target point selector 7, a determination target point coordinate transformer 8, a hidden determinator 9, a facility addition processing unit (storing processor) 10, a map mode setting unit 11, a facility selector (selector) 12, a display feature adder 13, and a display 14. The map display device further includes, as storage areas, a map database 21, an environmental parameter storage 22, a color buffer 23, a Z value buffer 24, and a facility list storage 25. These storage areas can be alternatively disposed outside the map display device 100.

The display range calculator 1 calculates a map range to be displayed in a map display screen of the display 14 on the basis of an operational input made by a user, such as a scroll operation. The model data acquiring unit 2 acquires information about all objects which construct the map data about the map range calculated by the display range calculator 1, for example, road information, topographical feature information, facility information, character information about roads, facilities, etc., and so on from the map database 21. Hereafter, topographical feature information, facility information, road information, and so on which construct map data are collectively referred to as model data.

The model selector 3 acquires model data about each map item type which is specified from the model data acquired by the model data acquiring unit 2. Map item types include, for example, a topographical model showing topographical undulations, a facility model showing a facility located in a surrounding area, and a character string model showing the name of a road, the name of a region, the name of a facility, or the like.

The transformation matrix calculator 4 calculates transformation matrices used for performing three-dimensional graphics drawing on two-dimensional map data on the basis of three-dimensional environmental parameters, such as visual point information, stored in the environmental parameter storage 22. The environmental parameter storage 22 stores, as the three-dimensional environmental parameters, a visual point position, a gazing point, a direction upward with respect to a line of sight, an angle of visibility in a Y direction, the Z values of the most front and the most back of a region which can be recognized visually from the visual point position, and so on. In this embodiment, an explanation will be made by assuming that as three-dimensional space, a width direction of the map data is defined as an X axis, a height direction of the map data is defined as a Y axis, and a depth direction of the map data is defined as a Z axis. The same definition is established in the subsequent embodiments.

The renderer 5 renders the model data selected by the model selector 3 with the transformation matrices calculated by the transformation matrix calculator 4. The rendering is a process of imaging and expressing the map data on the basis of a virtual visual point. The rendered data is written in the color buffer 23 and the Z value buffer 24. The color buffer 23 is a storage area that stores X coordinate values and Y coordinate values of the three-dimensional image rendered by the renderer 5. The Z value buffer 24 is a storage area that stores the position in a depth direction of each model in the three-dimensional image, i.e., the Z value of the coordinate values of each model on a per pixel basis, and stores the Z value of the three-dimensional image rendered by the renderer 5 while bringing the Z value into correspondence with an X coordinate and a Y coordinate.

The map movement determinator 6 determines whether or not the display range calculated by the display range calculator 1 is the same as the map range already displayed on the display 14. When the map movement determinator 6 determines that the display range calculated by the display range calculator 1 has moved, the determination target point selector 7 refers to the model data selected by the model selector 3 to acquire the coordinate values of determination points used for determining whether or not the model data is hidden behind other model data. The determination target point coordinate transformer 8 transforms the coordinate values of each of the determination points acquired by the determination target point selector 7 by using the transformation matrices calculated by the transformation matrix calculator 4.

The hidden determinator 9 compares the Z value of each of the determination points transformed by the determination target point coordinate transformer 8 with the Z value stored in the Z value buffer 24 to determine whether or not the selected model data is hidden behind other model data. In the determination, the hidden determinator makes a comparison with the Z value, which corresponds to the X and Y coordinates of the determination point, in the Z value buffer 24. When the hidden determinator 9 determines that the selected model data is not hidden behind any other model data, the facility addition processing unit 10 performs a process of adding the selected model data to a list. Concretely, when it is determined with a selected facility model is not hidden behind any topographical model, the facility addition processing unit stores the facility information about the facility model in the list. The facility list storage 25 stores an information list regarding each model, and, in the above-mentioned example, stores a selection target facility list in which pieces of facility information are listed.

The map mode setting unit 11 determines a map mode on the basis of an operational input made by the user. Map modes include a map mode in which only a general map is displayed, and a facility search mode in which a request is made of the user to select a surrounding facility and selected facility information is displayed. When the map mode determined by the map mode setting unit 11 is the facility search mode in which surrounding facilities are searched for, the facility selector 12 switches among the facility models in the selection target facility list stored in the facility list storage 25 on the basis of an operational input made by the user to select the facility models one by one.

When displaying the facility model selected by the facility selector 12 in the map display screen, the display feature adder 13 performs a process of adding a display feature for specifying the selected facility. Concretely, a process of enclosing the periphery of the facility model with a thick frame, a process of changing the display color of the facility model, a process of blinking the display of the facility model, a process of adding an arrow indicating the facility model, or a process of setting the display size of the facility model to be a large one is provided. The facility model to which the display feature is added is outputted to the renderer 5 and is rendered. The display 14 displays the model data rendered by the renderer 5 as the map display screen.

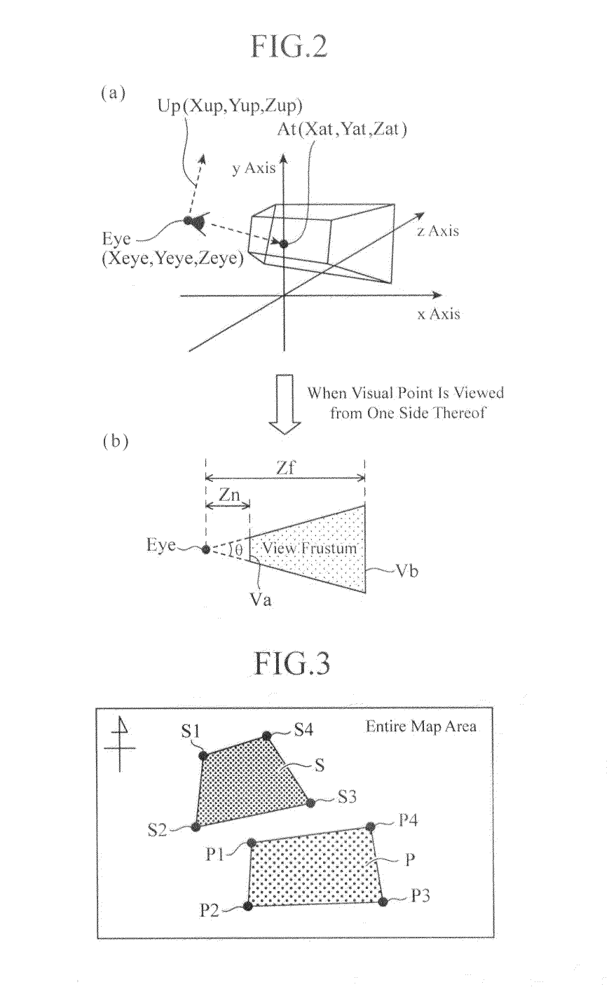

FIG. 2 is an explanatory drawing showing the environmental parameters of the map display device in accordance with Embodiment 1 of the present invention.

As shown in FIG. 2, as the environmental parameters, the visual point Eye, the gazing point At, the direction Up upward with respect to the line of sight, the angle of visibility theta in the Y direction, and the Z values of the most front Va and the most back Vb of the region (referred to as a view frustum from here on) which can be viewed from the position of the visual point Eye are provided. As shown in FIG. 2(a), the visual point Eye is expressed by (Xeye, Yeye, Zeye), the gazing point At is expressed by (Xat, Yat, Zat), and the direction Up upward with respect to the line of sight is expressed by (Xup, Yup, Zup). FIG. 2(b) is a view showing the visual point Eye which is viewed just from one side thereof. In this figure, the angle of visibility in the Y axis direction is expressed by theta, the distance from the visual point Eye to the most front Va of the view frustum is expressed by Zn, and the distance from the visual point Eye to the most back Vb of the view frustum is expressed by Zf.

Next, the color buffer 23 and the Z value buffer 24 will be explained.

The width and the height of display data stored in the color buffer 23 are expressed by Width and Height, respectively, and writing is performed on a per pixel basis with the color of the model data itself. The display data stored in the Z value buffer 24 has the same size as the display data stored in the color buffer 23, and the Z value of the model data is written on a per pixel basis. A value which is normalized to a value ranging from 0.0 to 1.0 is stored as the Z value, and a point closer to the visual point Eye has a smaller Z value. For example, the Z value of the most front Va of the view frustum shown in FIG. 2(b) is 0.0, and the Z value of the most back Vb of the view frustum is 1.0.

FIG. 3 is an explanatory drawing showing an outline of determination of a map movement which is performed by the map display device in accordance with Embodiment 1 of the present invention.

FIG. 3 shows an entire map area, and a predetermined map range in the entire map area is displayed as the map display screen. An initial map range S is currently being displayed on the display 14 as the map display screen, and is defined by (S1, S2, S3, S4) which are its four vertexes (an upper left initial point, a lower left initial point, a lower right initial point, and an upper right initial point) on the map. A case in which the initial map range S is moved to a map range P on the basis of the user's scroll operation or the like is shown. The map range P is defined by (P1, P2, P3, P4) which are its four vertexes (an upper left P point, a lower left P point, a lower right P point, an upper right P point) on the map. Because the four vertexes defining the map range P are the destinations of the movement of the four vertexes defining the initial map range S to different positions, respectively, it is determined that the map range P has moved from the initial map range S. As long as at least one of the four vertexes of the map range P is the one to which one vertex of the initial map range S has moved, it is determined that the map range has moved.

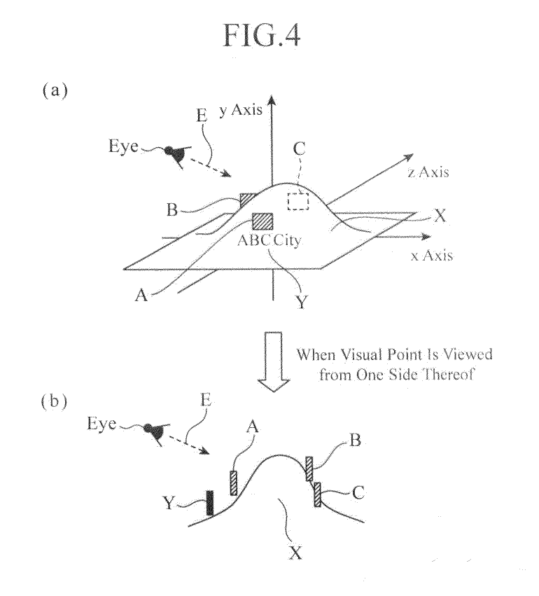

FIG. 4 is a view showing a display example of model data included in a map range of the map display device in accordance with Embodiment 1 of the present invention. FIG. 4(a) shows a three-dimensional display example of the map range, and FIG. 4(b) shows the map range when the visual point is viewed just from one side thereof.

In the example of FIG. 4, a case in which a topographical model, facility models of three facilities, and a character string model are displayed in the map range is shown, and a positional relationship among the models is shown. A topographical feature X showing undulations and so on is displayed as the topographical model, a facility A, a facility B, and a facility C which exist on the topographical feature X are displayed as the facility models, and a place name or the like is displayed as the character string model.

In the topographical model, an X value, a Y value, and a Z value are setup on a per pixel basis. Each of the facility models and the character string model is expressed by a billboard which is a polygonal plate-shaped model, and an X value, a Y value, and a Z value of the billboard region are set up on a per pixel basis. The sight line direction E is the same as the normal line to the surface of each billboard. Although a method of arranging the billboard of a facility model can be configured as appropriate, for example, the billboard is arranged in such a way that the position coordinates on the map where the facility is located are the center coordinates of the billboard region. Similarly, the billboard of the character string model is arranged in such a way that the position coordinates on the map of the point indicated by the character string are the center coordinates of the billboard region.

It is assumed that the sight line direction E of the visual point Eye is aligned with the direction of the Z axis of FIG. 4(a). Further, as shown in FIG. 4(b), when the models are viewed from the visual point Eye, there exists a region where all of the facility A can be recognized visually, but the facility B is hidden behind the topographical feature X and therefore a part of the facility cannot be recognized visually. In addition, the facility C cannot be recognized visually because all of the facility is hidden behind the topographical feature X. The example shown in FIG. 4 is displayed when the facility search mode is set in the map mode setting unit 11.

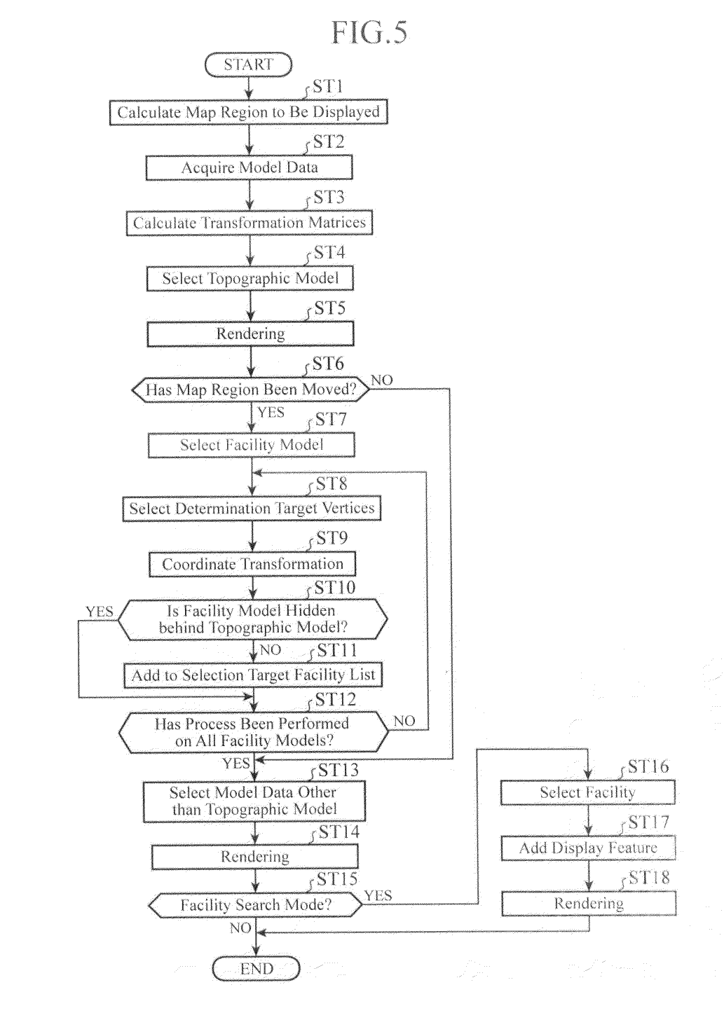

Next, the operation of the map display device 100 will be explained with reference to FIGS. 5 to 12. First, FIG. 5 is a flow chart showing the operation of the map display device in accordance with Embodiment 1 of the present invention. The operation of the map display device 100 consists of a first process of rendering the model data about a topographical model, a second process of determining whether or not a facility is hidden behind a topographical feature when it is determined that the map range has moved, and a third process of performing a facility search when the map mode is the facility search mode. First, the processes will be explained in order with reference to a concrete example, starting from the first process.

First Process: Rendering of the Model Data about a Topographical Model

The display range calculator 1 calculates a map range to be displayed on the basis of a scroll operation made by the user (step ST1). Although the map range is determined typically by using information including the scale, the latitude and longitude of the display center, and the bird's-eye view angle of the visual point, fundamentally, the map range can be freely determined by the developer. Hereafter, the explanation will be made by assuming that the determined map range is the map range P.

The model data acquiring unit 2 acquires the model data about all the map objects which construct the map range P with reference to the map database 21 (step ST2). As shown in FIG. 4, in this case, as the model data, the data about the topographical model (map object of a first type), the data about the facility models of the facilities A, B, and C (map objects of a second type), and the data about the character string model are acquired.

Next, the transformation matrix calculator 4 calculates transformation matrices for three-dimensional graphics by using the three-dimensional transformation parameters stored in the environmental parameter storage 22 (step ST3).

The transformation matrices which are the target for calculation are a view matrix (ViewMatrix), a projection matrix (ProjectionMatrix), and a viewport matrix (ViewportMatrix), and each of the matrices can be calculated as shown below. Although a matrix for transformation and movement of a model, which is called a world transformation matrix (WorldMatrix), is also set up, the explanation will be made by assuming that this matrix is a unit matrix in this Embodiment 1, for the sake of simplicity.

View Matrix

$$ViewMatrix = ( \begin{matrix}Xaxis \cdot x & Yaxis \cdot x & Zaxis \cdot x & 0 \\ Xaxis \cdot y & Yaxis \cdot y & Zaxis \cdot y & 0 \\ Xaxis \cdot z & Yaxis \cdot z & Zaxis \cdot z & 0 \\ - Xaxis \cdot Eye & - Yaxis \cdot Eye & - Zaxis \cdot Eye & 1\end{matrix} )$$

$$Zaxis = ( At - Eye ) / ‖ At - Eye ‖$$

$$Xaxis = ( Up \times Zaxis ) / ‖ Up \times Zaxis ‖$$

$$Yaxis = Zaxis \times Xaxis$$

Projection Matrix

$$ProjectionMatrix = ( \begin{matrix}cot ( θ / 2 ) * Height / Width & 0 & 0 & 0 \\ 0 & cot ( θ / 2 ) & 0 & 0 \\ 0 & 0 & Zf / ( Zf - Zn ) & 1 \\ 0 & 0 & - Zn * Zf / ( Zf - Zn ) & 0\end{matrix} )$$

Viewport Matrix

$$ViewPortMatrix = ( \begin{matrix}Width / 2 & 0 & 0 & 0 \\ 0 & - Height / 2 & 0 & 0 \\ 0 & 0 & 1 & 0 \\ Width / 2 & Height / 2 & 0 & 1\end{matrix} )$$

After the transformation matrices are calculated, the model selector 3 selects and acquires the model data about the topographical model from the model data acquired by the model data acquiring unit 2 in step ST2 (step ST4). The renderer 5 performs a rendering process of transforming the model data about the topographical model acquired in step ST4 by using the transformation matrices calculated in step ST3, and writes the data after the rendering in the color buffer 23 and the Z value buffer 24 (step ST5).

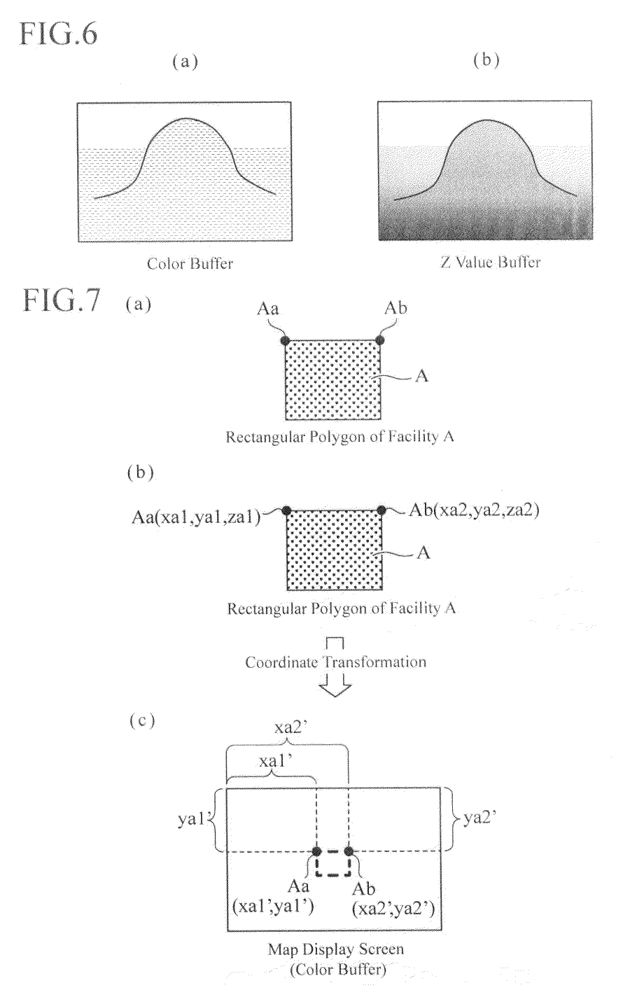

FIG. 6 is a view showing the rendering of the topographical model which is carried out by the map display device in accordance with Embodiment 1 of the present invention, FIG. 6(a) shows an example of the writing in the color buffer 23, and FIG. 6(b) shows an example of the writing in the Z value buffer 24.

As shown in FIG. 6(a), the writing is performed on the color buffer 23 on a per pixel basis by using the color of the model itself. On the other hand, as shown in FIG. 6(b), the Z value of the model data transformed by using the transformation matrices is written in the Z value buffer 24 on a per pixel basis. The Z value of the model data is normalized to a value ranging from 0.0 to 1.0 through the transformation using the transformation matrices, and is then stored, and is a one which decreases with close to the visual point Eye shown in FIG. 4.

When the rendering of the model data about the topographical model is performed in step ST5, the map movement determinator 6 determines whether the map range calculated in step ST1 has moved from the map range displayed the last time (step ST6). The map range displayed the last time can be configured so as to be temporarily stored in a storage area of the map movement determinator 6, or can be stored in an external storage area. Further, in the determining process of step ST6, a comparison between the positions of the four vertexes of the rectangle defining the map range displayed the last time and the positions of the four vertexes of the rectangle defining the map range calculated in step ST1 is made, and, when the position of at least one vertex, among the positions of the four vertexes, differs from that of the corresponding vertex, it is determined that the map range has moved. When the map range has moved (when YES in step ST6), the map display device advances to the second process (process of step ST7 and subsequent steps). On the other hand, when the map range has not moved (when NO in step ST6), the map display device advances to the third process (process of step ST13 and subsequent steps).

Second Process: Determination of Whether or not a Facility is Hidden Behind a Topographical Feature.

When the map range has moved (when YES in step ST6), the model selector 3 selects the model data about a facility model from the model data which the model data acquiring unit 2 acquires in step S2 (step ST7). In the example shown in FIG. 4, the three facility models: the facility A, the facility B, and the facility C can be selected. The determination target point selector 7 selects determination object vertices from the model data about each facility selected in step ST7 (step ST8). The determination object vertices are vertices used for determining whether the facility model is hidden behind the topographical model, and are two vertices located at the both ends of the upper side of the rectangular polygon which constructs the model data about the facility.

The determination target point coordinate transformer 8 performs a coordinate transformation on each of the determination object vertices selected in step ST8 by using the transformation matrices calculated in step ST3 (step ST9). The transformation matrices used for the coordinate transformation are the same as those used in the rendering process of rendering the topographical model in step ST5. The coordinate transformation on each of the determination object vertices in step ST9 is performed according to the following equation (1).

$$( X , Y , Z , w ) = ( x , y , z , 1 ) \times ViewMatrix \times ProjectionMatrix \times ViewPortMatrix \\ {x}^{′} = X / w , {y}^{′} = Y / w , {z}^{′} = Z / w \\ \{ \begin{matrix}\begin{matrix}( x , y , z ) … Three \text{-} Dimensional Coordinate Values of \\ Determination Target Vertex before Transformation\end{matrix} \\ \begin{matrix}( {x}^{′} , {y}^{′} , {z}^{′} ) … Three \text{-} Dimensional Coordinate Values of \\ Determination Target Vertex after Transformation \\ ViewMatrix … View Matrix \\ ProjectionMatrix … Projection Matrix \\ ViewPortMatrix … Viewport Matrix \end{matrix}\end{matrix} \qquad ( 1 )$$

In the three-dimensional coordinates (x′, y′, z′) of each of the determination object vertices transformed by the determination target point coordinate transformer 8, x′ and y′ are the coordinate values on the map display screen, i.e., in the color buffer 23, and z′ is the Z value in the Z value buffer 24.

FIG. 7 is an explanatory drawing showing the processes performed by the determination target point selector and the determination target point coordinate transformer of the map display device in accordance with Embodiment 1 of the present invention.

FIG. 7(a) shows the determination object vertices of the rectangular polygon of the facility A which the determination target point selector 7 selects, and the both ends of the upper side of the rectangular polygon construct the first determination object vertex Aa and the second determination object vertex Ab.

FIGS. 7(b) and 7(c) are explanatory drawings showing the coordinate transformation carried out by the determination target point coordinate transformer 8. The coordinate values of the first determination object vertex Aa of the rectangular polygon of the facility A are (xa1, ya1, za1), and the coordinate values of the second determination object vertex Ab of the rectangular polygon of the facility A are (xa2, ya2, za2). When coordinate transformation is carried out on the first determination object vertex Aa and the second determination object vertex Ab according to the above-mentioned equation (1), their coordinate values are transformed to coordinate values (xa1′, ya1′, za1′) and coordinate values (xa2′, ya2′, za2′), respectively. FIG. 7(c) shows the map display screen after the coordinate transformation, i.e., a display based on the data stored in the color buffer 23. The coordinate values of the first determination object vertex Aa are expressed by (xa1′, ya1′), and the coordinate values of the second determination object vertex Ab are expressed by (xa2′, ya2′).

The hidden determinator 9 compares the coordinate values of each of the determination object vertices on which the coordinate transformation is performed in step ST9 with the Z value which is stored in the Z value buffer 24 and which is acquired at the time of rendering the model data about the topographical model to determine whether or not each facility model is hidden behind the topographical model (step ST10). The determination of whether or not each facility model is hidden behind the topographical model uses an evaluation equation shown by the following equation (2).

Evaluation Equation for Hidden Determination:

$$( ZValue ( x {1}^{′} , y {1}^{′} ) \leq z {1}^{′} ) \& \& ( ZValue ( x {2}^{′} , y {2}^{′} ) \leq z {2}^{′} ) \\ \{ \begin{matrix}ZValue ( i , j ) … Z Value of Coordinates ( i , j ) in Z Buffer \\ \begin{matrix}( x {1}^{′} , y {1}^{′} , z {1}^{′} ) … Coordinate Values of Determination Target \\ Vertex ( First ) after Transformation\end{matrix} \\ \begin{matrix}( x {2}^{′} , y {2}^{′} , z {2}^{′} ) … Coordinate Values of Determination Target \\ Vertex ( Second ) after Transformation\end{matrix}\end{matrix} \qquad ( 2 )$$

According to the evaluation equation shown by the equation (2), when both the Z values of the first determination object vertex and the second determination object vertex after the coordinate transformation are larger than the Z value which is stored in the Z value buffer 24 and which is acquired at the time of rendering the model data about the corresponding topographical model, it is determined that the facility model is hidden behind the topographical model. In contrast, when the Z value of either one of the first determination object vertex and the second determination object vertex after the coordinate transformation is equal to or smaller than the rendered Z value of the topographical model, it is determined that the facility model is not hidden behind the topographical model.

When the facility model is hidden behind the topographical model (when YES in step ST10), the map display device advances to a process of step ST12. In contrast, when the facility model is not hidden behind the topographical model (when NO in step ST10), the facility addition processing unit 10 adds the facility data about the facility model which is determined not to be hidden behind the topographical model to the selection target facility list stored in the facility list storage 25 (step ST11). After that, the hidden determinator 9 determines whether it has performed the determining process on all the facilities (step ST12). When having performed the determining process on all the facilities (when YES in step ST12), the map display device advances to the third process (process of step ST13 and subsequent steps). In contrast, when not having performed the determining process on all the facilities yet (when NO in step ST12), the map display device returns to the process of step ST8 and repeats the above-mentioned processes.

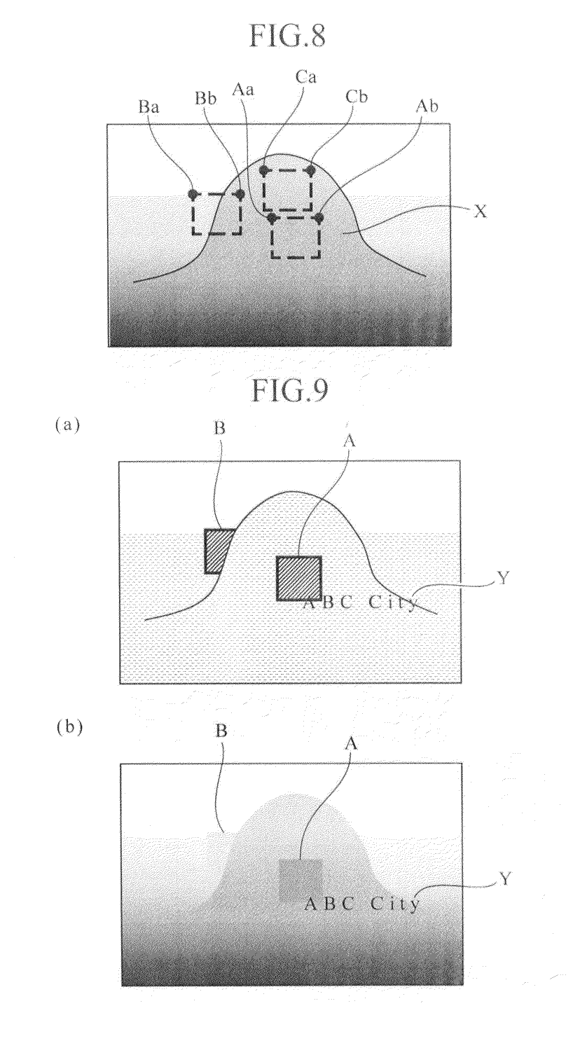

FIG. 8 is an explanatory drawing showing the hidden determining process performed by the map display device in accordance with Embodiment 1 of the present invention, and expresses the process with the Z value of the map range shown in FIG. 4.

Because both the first determination object vertex Aa and the second determination object vertex Ab of the facility A exist frontward with respect to the topographical feature X, it is determined in the determining process of step ST10 that both the Z values of the first and second determination object vertices Aa and Ab are equal or smaller than the Z value which is stored in the Z value buffer 24 and which is acquired at the time of rendering the model data about the topographical model. More specifically, it is determined that the facility A is not hidden behind the topographical feature X.

Similarly, because while the second determination object vertex Bb of the facility B exists rearward with respect to the topographical feature X, the first determination object vertex Ba exists frontward with respect to the topographical feature X, it is determined in the determining process of step ST10 that the Z value of at least one of the determination object vertices is equal to or smaller than the Z value stored in the Z value buffer 24. More specifically, it is determined with the facility B is not hidden behind the topographical feature X, In contrast, because both the first determination object vertex Ca and the second determination object vertex Cb of the facility C exist rearward with respect to the topographical feature X, it is determined in the determining process of step ST10 that both the Z values of the first and second determination object vertices Ca and Cb are larger than the Z value stored in the Z value buffer 24. More specifically, it is determined that the facility C is hidden behind the topographical feature X.

The facility addition processing unit 10 adds the facility data about the facilities A and B in the selection target facility list stored in the facility list storage 25 on the basis of the above-mentioned determining process on the facilities A to C.

Third Processing: Facility Search

When the determining process is performed on all the facility models (when YES in step ST12), the model selector 3 selects the model data other than the topographical model from the model data which the model data acquiring unit 2 acquires in step ST2 (step ST13), and the renderer 5 renders the selected model data other than the topographical model (step ST14).

FIG. 9 is a view showing a display example in the case of rendering the model data other than the topographical model in the map display device in accordance with Embodiment 1 of the present invention. Because all the map items are rendered by rendering the model data other than the topographical model, a general three-dimensional map is displayed. FIG. 9(a) shows an example of a display using the display data stored in the color buffer 23, and FIG. 9(b) shows an example of a display using the Z value stored in the Z value buffer 24.

Next, the map mode setting unit 11 determines whether or not the set mode is the facility search mode (step ST15). When the set mode is not the facility search mode (when NO in step ST15), the map display device ends the processing. In contrast, when the set mode is the facility search mode (when YES in step ST15), in response to the user's selection operation, the facility selector 12 selects the facility model of the facility selected with reference to the selection target list stored in the facility list storage 25 (step ST16). The display feature adder 13 performs a process of adding a display feature to the facility model of the facility selected in step ST16 (step ST17). After that, the renderer 5 carries out rendering (step ST18) and the map display device ends the processing.

When, in step ST15, the mode is set to the facility search mode according to the user's operation, the facility selector 12, in step ST16, selects one facility with reference to the selection target facility list stored in the facility storage 25. The facility selector 12 repeatedly performs a process of selecting one facility from the head of the selection target facility list, and then selecting the facility which is next to the facility previously selected. When the previously-selected facility is at the end of the selection target facility list, the facility selector returns to the head of the list and selects the facility. Because in the hidden determination results shown in FIG. 8, the facilities A and B are stored in the selection target facility list in step ST11, the facility selector 12 selects the facility A.

The display feature adder 13, in step ST17, performs a process of adding a thick frame to the periphery of the display icon of the selected facility A. The thick frame can be added by generating model data in which a width is provided for the periphery of the display icon of the facility A.

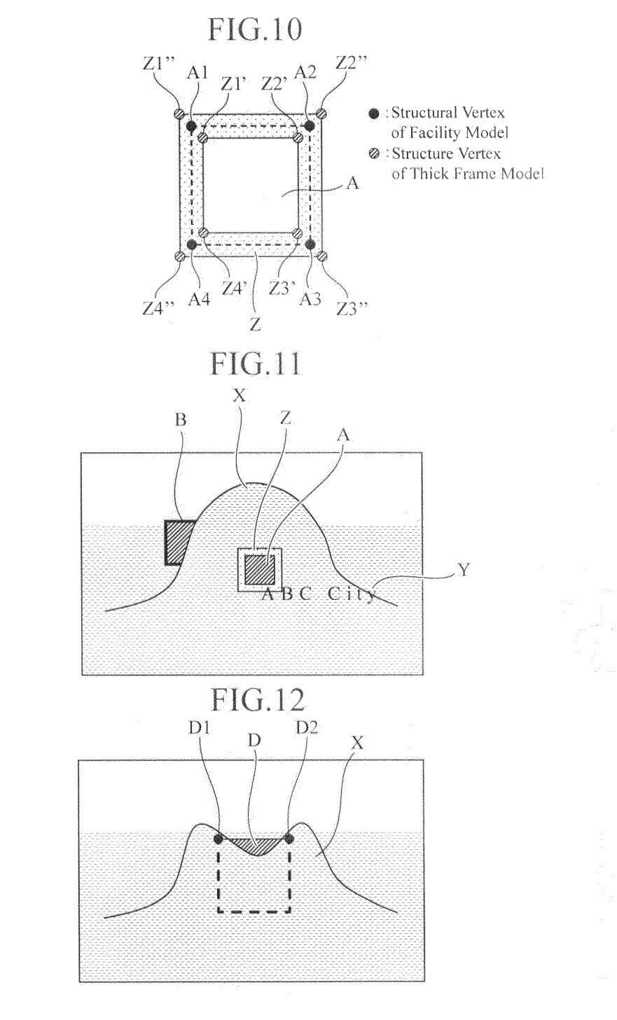

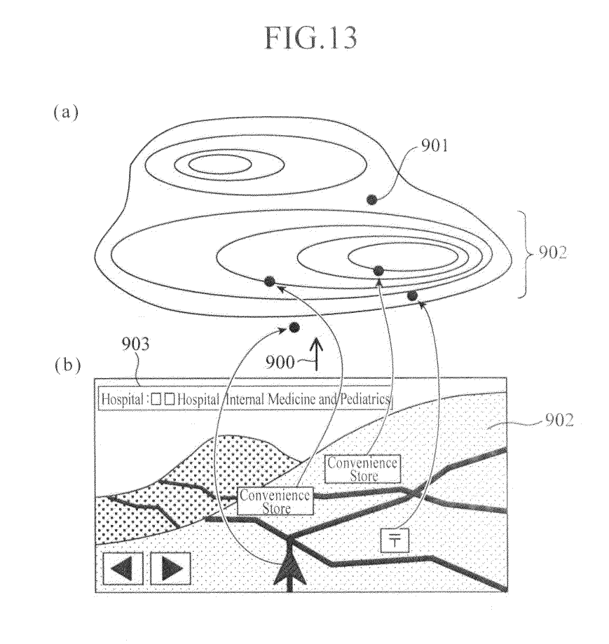

FIG. 10 is a view showing an example in which the display feature adder of the map display device in accordance with Embodiment 1 of the present invention adds a thick frame as a display feature. For the structural vertices A1, A2, A3, and A4 of the facility A, an inside frame Z′ having vertices Z1′, Z2′, Z3′, and Z4′ and an outside frame Z″ having vertices Z1″, Z2″, Z3″, and Z4″ are formed, and a region formed between the inside frame Z′ and the outside frame Z″ is defined as a thick frame model Z.

The renderer 5, in step ST18, renders the model data about the facility model to which the display feature is added.

FIG. 11 is a view showing a display example in the case of adding a display feature in the map display device in accordance with Embodiment 1 of the present invention.

In the example of FIG. 11, a result of rendering the facility model of the facility A and the thick frame model Z is shown, and the periphery of the facility A is enclosed by a thick frame, so that the facility A is highlighted. The map display screen shown in FIG. 11 is displayed on the display 14, and, as a result, the series of operations in the flow chart shown in FIG. 5 is completed.

After that, when the user selects the next facility without performing a scroll operation, although the processing is started from the head of the flow chart shown in FIG. 5, the second process is omitted because no movement occurs in the display range after the model data about the topographical model is rendered in the first process, and, in the third process, the facility selector 12 selects the facility B which is next to the previously-selected facility A and the display feature adder 13 adds a display feature and displays the facility B. In addition, because the facility which the facility selector 12 selects the last time is the one at the end of the selection target facility list when there is no update of the selection target facility list in the user's next facility selection process, the map display device returns to the head of the list and the facility A is selected, and a display feature is added by the display feature adder 13 and the facility A is then displayed. More specifically, the map display device is constructed in such a way as to, even when the user repeats a facility selection, be unable to select a facility model which is hidden behind the topographical model, i.e., the facility C in the example of FIG. 4.

In the above-mentioned explanation, in the determination of whether or not a facility model is hidden behind the topographical model, the both ends of the upper side of the rectangular polygon of the facility model are defined as two determination object vertices, and whether the facility model is hidden behind the topographical model is determined by comparing the Z value of each of the two determination object vertices with the Z value of the rendered topographical model. However, as shown in FIG. 12, there is a case in which the two determination object vertices D1 and D2 of a facility D are hidden behind a topographical feature X, but a part of the facility D is not hidden behind the topographical feature and can be recognized visually. In order to support such a case, in addition to the two vertices at the both ends of the upper side of the rectangular polygon of the facility model, a determination target point, such as a middle point on the upper side, can be disposed on the upper side, the map display device can be constructed in such a way as to determine whether or not the facility model is hidden behind the topographical model by using the three points on the upper side of the rectangular polygon. As a result, the precision of the determination of whether or not the facility model is hidden behind the topographical model can be improved.

Further, a determination object vertex can be disposed on a side other than the upper side of the rectangular polygon, and the determining process can be performed with the number of determination object vertices being increased as appropriate.

As mentioned above, because the map display device according to this Embodiment 1 is constructed in such a way as to include the hidden determinator 9 that compares the Z value of each of two vertices of a facility model which are determination objects with the Z value of a rendered topographical model to determine whether or not the facility model is hidden behind the topographical model, the number of times that the comparing process for the hidden determination is performed can be suppressed, and the determining process can be speeded up.

Further, because the hidden determinator 9 according to this Embodiment 1 is constructed in such a way as to perform the hidden determination only by performing a matrix operation on the model data about the facility model which is the target for the hidden determination without rendering the model data about the facility model and storing a result of the rendering in the Z value buffer 24, the hidden determination can be implemented by performing the matrix operation which can be performed at a higher speed than the typical rendering process, and the process can be speeded up.

In addition, because the map display device according to this Embodiment 1 is constructed in such a way as to remove a facility model which is hidden behind a topographical model from the selection target facility list, and, when even a part of a facility model is not hidden behind any topographical model, adds this facility to the selection target facility list, and enables the user to select only a facility listed in the selection target facility list, the map display device can prevent a situation in which the user gets confused when selecting a facility, such as a situation in which no icon of a facility is displayed, but a character string showing facility information about the facility is displayed. In addition, because the map display device carries out the generation of the selection target facility list when the map range has moved, the map display device can prevent the list from being generated uselessly at the time of producing a general map display.

While the invention has been described in its preferred embodiment, it is to be understood that various changes can be made in an arbitrary component according to the embodiment, and an arbitrary component according to the embodiment can be omitted within the scope of the invention.

### INDUSTRIAL APPLICABILITY

Because the map display device in accordance with the present invention can perform the determining process of determining whether or not a facility is hidden behind a topographical feature at a high speed, the map display device is suitable for use in a navigation device having a function of searching for facilities located around a vehicle and displaying the facilities.

### EXPLANATIONS OF REFERENCE NUMERALS

1 display range calculator, 2 model data acquiring unit, model selector, 4 transformation matrix calculator, 5 renderer, 6 map movement determinator, 7 determination target point selector, 8 determination target point coordinate transformer, 9 hidden determinator, 10 facility addition processing unit, 11 map mode setting unit, 12 facility selector, 13 display feature adder, 14 display, 21 map database, 22 environmental parameter storage, 23 color buffer, 24 Z value buffer, 100 map display device.

1. A map display device that draws and displays a map image having a three-dimensional expression in which a positional relationship in a depth direction among a plurality of map objects which construct map data is shown, said map display device comprising:
a transformation matrix calculator that calculates a transformation matrix for transforming said map data into three-dimensional data on a basis of a virtual visual point position for said map image having a three-dimensional expression, a sight line direction, and a three-dimensional parameter which is specified on a basis of said visual point position and said sight line direction;
a renderer that renders object information about said map object of a first type with the transformation matrix calculated by said transformation matrix calculator, and generates three-dimensional image element data; and
a hidden model determinator that selects a determination target point from object information about said map object of a second type, performs a coordinate transformation on said determination target point with the transformation matrix calculated by said transformation matrix calculator, and compares a coordinate value in the depth direction of the determination target point on which the coordinate transformation is performed with a coordinate value in the depth direction of the three-dimensional image element data generated by said renderer to determine whether or not said map object of said second type is hidden behind said map object of said first type.

2. The map display device according to claim 1, wherein said map display device comprises a storing processor that stores object information about said map object of said second type which said hidden model determinator determines is not hidden behind said map object of said first type, a map mode inputter that accepts a search command for searching for said map object of said second type, a selector that selects a map object of the second type from the object information which said storing processor stores when receiving the search command for searching for said map object of said second type via said map mode inputter, and a display feature adder that adds a visual feature to said map object of said second type selected by said selector, wherein said renderer renders said map object of said second type selected by said selector and the visual feature which said display feature adder adds, and draws the map object and the visual feature in said map image.

3. The map display device according to claim 1, wherein said map display device comprises a display range calculator that calculates a map range of said map image to be displayed according to an operational input, a map movement determinator that determines whether the map range calculated by said display range calculator has moved from a map range which is calculated last time, and said hidden model determinator performs the comparison between the coordinate values in the depth direction only when said map movement determinator determines that the map range has moved.

4. The map display device according to claim 1, wherein said hidden model determinator selects at least two points located on an upper side of a billboard polygon of said map object of said second type as said determination target point.

5. The map display device according to claim 4, wherein when a coordinate value in the depth direction of at least one of at least said two determination target points is equal to or smaller than that in the depth direction of the three-dimensional image element data generated by said renderer, said hidden model determinator determines that said map object of said second type is not hidden behind said map object of said first type.

6. The map display device according to claim 2, wherein said display feature adder adds highlighting to said map object of said second type selected by said selector, changes a display color of said map object of said second type, or changes a display size of said map object of said second type.
